(19) United States
(12) Patent Application Publication
(10) Pub. No.: US 2010/0102238 A1
(43) Pub. Date: Apr. 29, 2010

(54) LUMINESCENCE QUANTUM EFFICIENCY MEASURING INSTRUMENT

(75) Inventors: Shusuke Kanazawa, Ueda-shi (JP); Musubu Ichikawa, Ueda-shi (JP); Yoshio Taniguchi, Ueda-shi (JP)

Correspondence Address: OLIFF & BERRIDGE, PLC, P.O. BOX 320850, ALEXANDRIA, VA, 22320-4850, US

(73) Assignees: SHINSHU UNIVERSITY, MATSUMOTO-SHI (JP); SYSTEMS ENGINEERING INC., TOKYO (JP)

(21) Appl. No.: 12/452,220

(22) PCT Filed: Jun. 25, 2008
(86) PCT No.: PCT/JP2008/061523

§ 371 Date: Dec. 22, 2009

(30) Foreign Application Priority Data
Jun. 27, 2007 (JP) 2007-169556

(51) Int. Cl. G01T 1/20

(52) U.S. Cl. 250/363.01; 250/368

(57) ABSTRACT

A luminescence quantum efficiency measuring instrument is provided for easily and surely changing luminescence of a luminescent sample exhibiting strong luminescence anisotropy into an isotropic luminescence and for accurately measuring the luminescence quantum efficiency of the luminescent sample. The luminescence quantum efficiency measuring instrument comprises an integrating sphere (1) having a center, an excitation light entrance window (2), and a detection probe end (3) connected to a spectroscope, the excitation light entrance window and the detection probe end being disposed in respective directions perpendicular to each other on a plane including the center, wherein a luminescent sample (5) is disposed inside the integrating sphere (1) and on a vertical line extending from the center and vertical to the plane, and a baffle plate (7) is disposed at a place through which the luminescent sample (5) is seen from the detection probe end (3).

### TECHNICAL FIELD

This invention relates to a luminescence quantum efficiency measuring instrument for accurately measuring a luminescence quantum efficiency of a fluorescence luminescent object.

### BACKGROUND OF THE INVENTION

The luminescence quantum efficiency of a fluorescence luminescent object is an important value for evaluating luminescence performance of a light emitting device containing the fluorescence luminescent object as a luminescent material. The luminescence quantum efficiency (η) can be calculated from the following formula using the number of photons (N_{EX}) of an excitation light absorbed by a luminescent sample and the number of photons (N_{EM}) emitted by luminescence of the luminescent sample.

η=N_{EM}/N_{EX}

Luminescence of a luminescent sample is, in many cases, is otropic luminescence and reaches in all directions. However, among luminescent samples, there are some materials that exhibit luminescence anisotropy and emit strong luminescence only from a certain surface of, for example, a flat-plate type crystal. When the luminescent sample exhibits luminescence anisotropy, the luminescence quantum efficiency calculated from the N_{EM}, which is observed from a certain direction, possesses extremely low reliability. To eliminate this drawback, in measuring the luminescence quantum efficiency, an integrating sphere has been conventionally used to change the luminescence of the luminescent sample into an isotropic luminescence (this process is called hereinafter as “isotropization”). The inner wall of the integrating sphere is coated with a light-scattering reflective material. By repeated diffused reflection of the luminescence of the luminescent sample inside the integrating sphere, the luminescence anisotropy of the sample is resolved. In the Japanese unexamined patent publication of JP 2003-215041, a method and device for measuring an absolute fluorescence quantum efficiency of a solid sample using an integrating sphere is disclosed.

The luminescent sample in the integrating sphere is usually installed, in an inclining manner, on an inclined sample platform, in order to prevent excitation light entered from outside the integrating sphere from being regularly reflected on the surface of a luminescent sample and going away out of the integrating sphere through an entrance window again. In order to install the sample near the center of the integrating sphere, a supporting rod is used to support the sample. In such cases, the surfaces of the inclined sample platform and the supporting rod should be subjected to a special surface treatment in order to be coated with a light-scattering reflective material, like the inner wall of the integrating sphere. If this surface treatment is incompletely finished, isotropization of the luminescence of the luminescent sample is disturbed. In addition, even if the surfaces of the inclined sample platform and supporting rod are properly finished, the presence of the inclined sample platform and the supporting rod may make a shadow to possibly cause a negative impact on the isotropization. Especially in a case where the luminescent sample exhibits high luminescence anisotropy, it has been difficult to completely change the anisotropic luminescence into an isotropic one.

### SUMMARY OF THE INVENTION

This invention was made to solve aforementioned problems, and an object of the present invention is to easily and certainly change luminescence of a luminescent sample exhibiting strong luminescence anisotropy into an isotropic luminescence and to provide a luminescence quantum efficiency measuring instrument for accurately measuring the luminescence quantum efficiency of luminescent samples.

The luminescence quantum efficiency measuring instrument which was made to attain the aforementioned purpose comprises;

an integrating sphere having a center;

an excitation light entrance window; and

a detection probe end connected to a spectroscope, the excitation light entrance window and the detection probe end being disposed in respective directions perpendicular to each other on a plane including the center,

wherein,

a luminescent sample is disposed inside the integrating sphere and on a vertical line extending from the center and vertical to the plane, and a baffle plate is disposed at a place through which the luminescent sample is seen from the detection probe end.

The luminescence quantum efficiency measuring instrument further comprises an excitation light source disposed outside the integrating sphere and on an extended line extending from the luminescent sample to and beyond the excitation light entrance window.

The luminescence quantum efficiency measuring instrument has an installation platform of the luminescent sample, the installation platform being detachably attached toward the inside from the outside of the integrating sphere.

The luminescence quantum efficiency measuring instrument of the present invention has a configuration in which a luminescent sample is horizontally installed at a lower pole portion in the integrating sphere and excitation light for exciting the luminescent sample is entered into the integrating sphere from a position on the equator line of the integrating sphere, therefore there is no need to provide in the integrating sphere foreign matters such as an inclined sample platform or supporting rod which could disturb a diffused reflection. Accordingly even luminescence of a luminescent sample exhibiting strong luminescence anisotropy can be surely changed into an isotropic luminescence in an integrating sphere. Accordingly when this luminescence quantum efficiency measuring instrument is used, luminescence quantum efficiency can be measured with high accuracy and reproducibility for any given luminescent sample.

### BRIEF EXPLANATION OF THE DRAWINGS

FIG. 1 is a perspective view showing an integrating sphere used in a luminescence quantum efficiency measuring instrument of the present invention.

FIG. 2 is a sectional view of the integrating sphere used in the luminescence quantum efficiency measuring instrument of the present invention.

FIG. 3 is a sectional view at the time of installing a luminescent sample in the integrating sphere having a horizontal installation platform of the luminescence quantum efficiency measuring instrument of the present invention.

Typical reference numerals are:

1: integrating sphere, 2: excitation light entrance window, 3: detection probe end, 4: sample installation port, 5: luminescent sample, 6: horizontal installation platform, 7: baffle plate, 8: optical fiber

### DETAILED EXPLANATION OF THE INVENTION

Hereinafter, examples of the present invention will be described in detail. However, it is noted that the scope of the present invention is not limited to these examples.

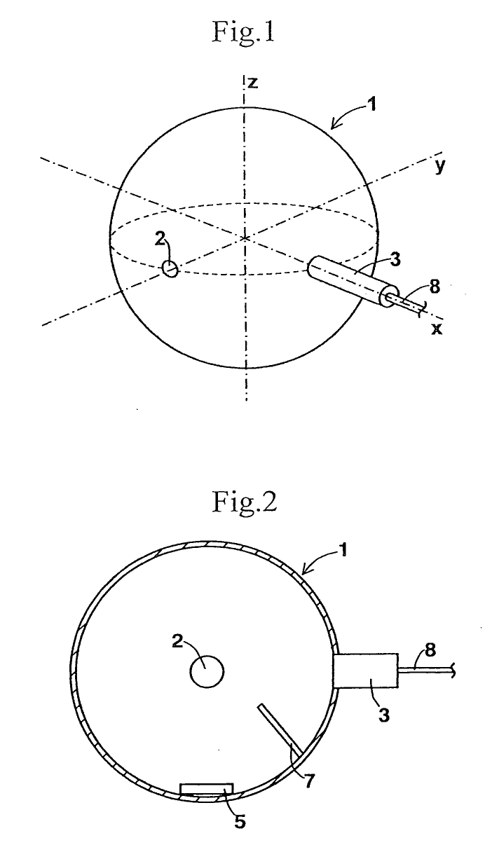

One embodiment of the luminescence quantum efficiency measuring instrument of the present invention will be explained referring to FIGS. 1 to 3.

The present luminescence quantum efficiency measuring instrument has at least one integrating sphere 1 as shown in FIGS. 1 and 2. The integrating sphere 1 has an excitation light entrance window 2 for introducing excitation light to excite a luminescent sample and a detection probe end 3 connected to a spectroscope that analyzes isotropic light obtained by isotropization in the integrating sphere. The excitation light entrance window 2 and the detection probe end 3 are each disposed in respective directions perpendicular to each other on a plane including the center of the integrating sphere 1. In other words, they are disposed, for example, on the equator line (dotted line) of the integrated sphere 1 having the Z axis as a central axis as shown in FIG. 1. The degree of longitude of the detection probe end 3 on the integrating sphere is 90 degrees with respect to the degree of longitude of the excitation light entrance window 2. The luminescent sample 5 is installed on a vertical line extending from the center of the integrating sphere 1 and perpendicular to the plane including the center, in other words, for example, the luminescent sample is installed horizontally and directly on a lower pole portion inside the integrating sphere 1 having the Z axis as a central axis as shown in FIG. 1. Between the luminescent sample 5 and the detection probe end 3, a baffle plate 7 is provided to prevent luminescence of the luminescent sample 5 from directly entering into the detection probe end 3. The surface of the inner wall of the integrating sphere 1 and the baffle plate 7 are coated with light reflective material such as barium sulfate.

Incident excitation light (not shown) entered into the integrating sphere 1 through the excitation light entrance window 2 from an excitation light source (not shown) installed outside the integrating sphere irradiates the luminescent sample 5 at a certain angle with respect to the sample. The luminescent sample 5 irradiated with the excitation light is excited, and then emits light. The emitted light is repeatedly and diffusively reflected inside the integrating sphere 1 and is changed into an isotropic light. There is no foreign matter, which may disturbs diffused reflection, such as an inclined sample platform or a supporting rod in the integrating sphere 1. Therefore, luminescence of a sample exhibiting a strong luminescence anisotropy, in which luminescence intensity varies at different sites of the sample, can be surely changed into an isotropic luminescence.

The isotropic luminescence thus obtained by isotropization is detected by the detection probe end 3 and measured by a spectroscope (not shown) such as a spectrometer and then the luminescence quantum efficiency of the luminescent sample is calculated. The calculation of the luminescence quantum efficiency can be carried out using publicly known computing equations. In addition, prior to calculate the luminescence quantum efficiency of a luminescent sample, it is necessary to previously measure spectroscopic spectra of the light of a spectral irradiance standard lamp and excitation light to be used. And then it is necessary to previously calibrate the integrating sphere and the spectroscope to be used using respective measured spectra data. Concrete calibration procedures are as follows.

Calibration of spectral sensitivity is carried out using a spectral irradiance standard lamp, DC stabilized power source, standard lamp and installation mount of the luminescence quantum efficiency measuring instrument. At first, the spectral irradiance standard lamp is installed at a specified position, light is switched on under the rated condition, and then the spectroscopic spectrum of the light entered into the integrating sphere is measured.

An inspection data of the spectral irradiance standard lamp is registered previously on a computer, and a spectral sensitivity calibration value (CAL: unit count/μW/cm²·nm) is evaluated from the inspection data (STD: unit μW/cm²·nm) and a measured spectrum data (MES std: unit count). Next, the integrating sphere in which the luminescent sample is not yet installed is irradiated with excitation light and the spectroscopic spectrum of the excitation light is measured. And a spectral radiant intensity (Ex: unit μW/cm²·nm) of the excitation light is evaluated through arithmetic operations using the measured spectrum data (MES blank: unit count) and the spectral sensitivity calibration value (CAL). Next, the luminescent sample is installed at a specified position in the integrating sphere. The luminescent sample is irradiated with the excitation light and the spectroscopic spectrum of the luminescent sample is measured. The spectral radiant intensity (Em: unit μW/cm²·nm) of the luminescence of the luminescent sample is evaluated through arithmetic operations using the measured spectrum data (MES sample: unit count) and the spectral sensitivity calibration value (CAL). From the evaluated values obtained by procedures mentioned above, the luminescence quantum efficiency of the luminescent sample is calculated. The wavelength range of the excitation light (Wave (1)) and the wavelength range of the luminescence of the luminescent sample (Wave (2)) should be specified previously. The number of photons (Ex (1)) in the wavelength range (Wave (1)) of the Ex, the number of photons (Em(1)) in the wavelength range (Wave(1)) of the Em and the number of photons (Em(2)) in the wavelength range (Wave(2)) of the Em are calculated. When the Em (1) is subtracted from the Ex(1), the number of photons (Abs) absorbed by the luminescent sample are calculated. When the Em (2) is divided by the Abs, luminescence quantum efficiency of the luminescent sample can be calculated.

The spectroscope may be directly connected to the detection probe end 3, or may be connected to the detection probe end 3 through an optical fiber 8.

The detection probe end 3 is most preferably disposed at a position of 90 or 270 degrees of longitude with respect to the longitude of the excitation light entrance window 2 on the integrating sphere 1 having the Z axis as a central axis as shown in FIG. 1, but it may be located at any degree of longitude as long as the degree of longitude is not at a position of 180 degrees with respect to that of the excitation light entrance window 2.

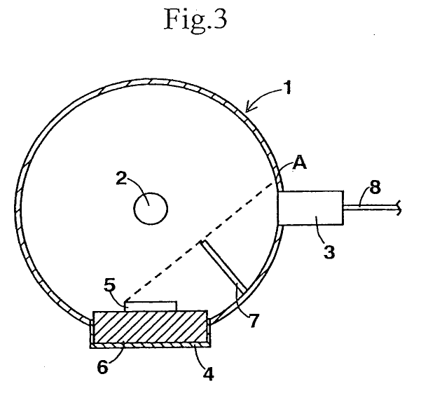

As shown in FIG. 3, the integrating sphere may have a sample installation port 4 and a horizontal installation platform 6 which are detachably attached toward the inside from the outside of the integrating sphere, to install the luminescent sample 5. The height of the horizontal installation platform 6 is adjusted such that the horizontal installation platform preferably protrudes upward a little bit from the sample installation port 4. At this time, the height of the horizontal installation platform 6 is adjusted in such a manner that the point A is higher than the detection probe end 3 (as shown in FIG. 3). The point A is an intersection of a line connecting the farthest edge of the luminescent sample 5 from the detection probe end 3 and the edge of the baffle plate 7, and the wall surface of the integrating sphere near the detection probe end 3. The horizontal installation platform 6 can be any shape as long as it has a horizontal sample-installation surface, but the platform 6 preferably has a cylindrical shape having the same diameter as the inner diameter of the port 4. The inner wall of the sample installation port 4 and the surface of the horizontal installation platform 6 are coated with the same light reflection material as that of the inner wall of the integrating sphere.

An example of measurement of the luminescence quantum efficiency of a luminescent sample using luminescence quantum efficiency measuring instrument of the present invention is shown in Example 1, and a comparative example of measurement of the luminescence quantum efficiency of the luminescent sample using a luminescence quantum efficiency measuring instrument which is outside the present invention is shown in Comparative Example 1.

### Example 1

A flat plate-like single crystal of an organic fluorescent substance shown in the following chemical formula (1) was used as the luminescent sample exhibiting strong luminescence anisotropy. This organic fluorescent substance emits strong luminescence only from an edge portion of the flat plate-like crystal. This luminous sample was installed horizontally on a lower pole portion in the integrating sphere having a configuration shown in FIG. 2, and luminescence quantum efficiency was measured. The surface of the inner wall and baffle plate of this integrating sphere were coated with barium sulfate. In addition, the excitation light entrance window and the detection probe end were disposed on the equator line of the integrating sphere and the degree of longitude of the detection probe end with respect to that of the excitation light entrance window was 90 degrees. A light-emitting diode was used for generating excitation light having a center wavelength of 397 nm and a half-value width of 15 nm. The same measurement was repeated 6 times using the same luminescent sample.

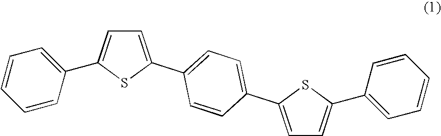

### Comparative Example 1

Luminescence quantum efficiency of the luminescent sample was measured according to Example 1 except that a conventional integrating sphere, in which the luminescent sample was installed at the lower pole portion of the integrating sphere using an inclined sample platform and the excitation light was entered from an upper pole portion of the integrating sphere, was used instead of the integrating sphere used in Example 1.

The respective measurement results are shown in Table 1.

TABLE 1

Luminescence quantum efficiency

| Measurement | Example 1 | Comp. Example 1 |
|---|---|---|
| 1st | 0.489 | 0.467 |
| 2nd | 0.469 | 0.507 |
| 3rd | 0.467 | 0.459 |
| 4th | 0.463 | 0.541 |
| 5th | 0.448 | 0.321 |
| 6th | 0.445 | 0.472 |

As is clear from Table 1, when the luminescence quantum efficiency measuring instrument of the present invention was used, there was no variation in the measured values of luminescence quantum efficiency and almost the same measured values were obtained. On the contrary, in the Comparative Example 1 there was a large variation in the data obtained in each measurement though the measurements were all carried out under the same conditions, the difference between the maximum and minimum values was as large as 0.220.

### INDUSTRIAL APPLICABILITY

The luminescence quantum efficiency measuring instrument of the present invention is useful for measuring with high accuracy and reproducibility the luminescent quantum efficiency of a luminescent material exhibiting strong luminescence anisotropy.

What is claimed it:

1. A luminescence quantum efficiency measuring instrument comprises:
an integrating sphere having a center;
an excitation light entrance window; and
a detection probe end connected to a spectroscope,
the excitation light entrance window and the detection probe end being disposed in respective directions perpendicular to each other on a plane including the center,
wherein,
a luminescent sample is disposed inside the integrating sphere and on a vertical line extending from the center and vertical to the plane, and a baffle plate is disposed at a place through which the luminescent sample is seen from the detection probe end.

2. The luminescence quantum efficiency measuring instrument according to claim 1 further comprises an excitation light source disposed outside the integrating sphere and on an extending line extending from the luminescent sample to and beyond the excitation light entrance window.

3. The luminescence quantum efficiency measuring instrument according to claim 1, wherein an installation platform of the luminescent sample is detachably attached toward the inside from the outside of the integrating sphere.
